(19) United States
(12) Patent Application Publication
(10) Pub. No.: US 2008/0265016 A1
(43) Pub. Date: Oct. 30, 2008

(54) System and a Method for Facilitating Paying for a Parking Permit in a Selected One of One or More Pay-for-Parking Zones

(76) Inventors: Lawrence William Paul Fitzgerald, Limerick (IE); Philip Martin Hayes, Clare (IE)

Correspondence Address: SUGHRUE MION, PLLC, 2100 PENNSYLVANIA AVENUE, N.W., SUITE 800, WASHINGTON, DC, 20037, US

(21) Appl. No.: 11/720,077

(22) PCT Filed: Nov. 24, 2005
(86) PCT No.: PCT/IE2005/000133

§ 371 Date: May 5, 2008

(30) Foreign Application Priority Data
Nov. 24, 2004 (IE) S2004/0791

(51) Int. Cl. G07C 1/30

(52) U.S. Cl. 235/378

(57) ABSTRACT

A system (1) for issuing parking permits in pay-for-parking zones, for example, permits for short-term street parking in local authority areas comprises a central control terminal (2) which controls operation of the system. Clients wishing to avail of the system (1) obtain a visual display device (3) for mounting in his or her motor vehicle for displaying the expiry time of the parking permit, and register with the system (1). The central control terminal (2) is controlled by a computer (7) and each client of the system is identified by his or her mobile telephone number, which is cross-referenced with an address code of the visual display device (3) in an ID memory (8) of the central control terminal (2). Each client of the system, in general, maintains a positive credit balance in his or her account in an account memory (14) of the central control terminal (2). On a telephone request being made from the mobile telephone of the client for a parking permit, the computer (7) computes the cost of the parking permit and debits the cost to the client's account in the account memory (14), and relays particulars of the parking permit granted through a telecommunications data link (15) to a radio paging network operator (16) for radio transmission to the visual display device (3) of the client, which is then displayed on a visual display screen (23) of the visual display device (3).

The present invention relates to a system for facilitating paying for a parking permit in a selected one of one or more pay-for-parking zones, and the invention also relates to a method for facilitating paying for a parking permit in a selected one of one or more pay-for-parking zones.

Local authorities in most cities and towns now charge a tariff for parking a car, van or other motor vehicle on streets and roads within the city or town, and indeed, on the periphery of cities and towns. Additionally, local authorities which operate car parks, in general, also charge a tariff for parking in such car parks. Private companies which operate car parks also charge a tariff for parking. In the case of most street and road parking where local authorities charge a tariff for parking, and also in the case of local authority operated car parks, in general, the parking tariff must be prepaid prior to the commencement of parking, although in many privately operated car parks, the parking tariff may be discharged on leaving the car park. Prepayment for local authority parking, in general, is made through ticket issuing machines which issue a prepaid ticket indicating the grant of a parking permit for a predetermined time period. This generally requires paying for the parking permit ticket by cash. In general, local authority parking permit ticket issuing machines are coin operated, and when the appropriate amount of the tariff has been entered in coins, the parking permit ticket issues.

A further complication of parking in local authority controlled areas is that in many cases the city or town is divided into parking zones, and the tariff for parking per predetermined parking time unit varies from zone to zone. Thus, it is essential to obtain a ticket from a ticket issuing machine which issues tickets for the appropriate zone.

Such local authority prepayment systems for parking are particularly undesirable, and are particularly inconvenient. Firstly, a person wishing to park may not have the appropriate change in coinage for the parking tariff, and where an individual does have sufficient change, if the change does not sum to the exact amount of the tariff, in general, local authority parking permit ticket issuing machines do not return change in respect of an overpayment, and thus, one can find oneself in many instances significantly overpaying for a parking permit. A further disadvantage of such local authority systems is that parking permit ticket issuing machines may be located some distance from an area in which parking is required, and furthermore, in general, such parking permit ticket issuing machines are provided in the open on footpaths and the like, and thus, in wet Weather obtaining a parking permit ticket from such ticket issuing machines is a particularly unpleasant experience.

In privately operated car parks, in general, one discharges the parking tariff on leaving the car park, and this, in general, is carried out by inserting a ticket issued when entering the car park in a ticket cancelling machine and inserting in coins or notes the appropriate parking tariff in order to cancel the ticket. While such ticket cancelling machines in general return change in respect of an overpayment, and furthermore, accept bank notes, in general, the bank note handling mechanism of such ticket cancelling machines is rather sensitive, and in general, such machines do not accept used or worn bank notes. Thus, one is very often faced with having to pay a relatively large tariff by coinage. Some ticket cancelling machines do accept credit and charge cards and debit a credit or charge card account with the parking tariff, however, in general, the amount of a typical parking tariff does not justify the use of a credit or charge card.

Attempts have been made to overcome these problems of paying for parking in local authority controlled parking areas and indeed, in privately operated car parks, however, none have successfully addressed the problem. One such system permits payment for a parking permit to be obtained by a mobile telephone, with payment being made by a credit or charge card. Under this system parking permit ticket issuing machines display a telephone number of a parking permit ticket authorising authority, which a person wishing to obtain a parking permit ticket calls from a mobile telephone to request the parking permit ticket from the ticket issuing machine. On providing a credit or charge card number to the ticket authorising authority, and on the payment being authorised by the credit or charge card authority, the authorising authority transmits a signal to the ticket issuing machine, which issues the parking permit ticket. However, this system fails to adequately address the problems discussed above. Firstly, an individual must walk to the ticket issuing machine, and stand at the ticket issuing machine until the ticket has been issued, and in wet weather, this can be a particularly unpleasant task. Secondly, this known system requires relatively small amounts to be debited against a credit or charge card, which in general, is undesirable.

There is therefore a need for a system and a method for facilitating paying for a parking permit for parking in local authority controlled areas, and indeed, also for parking in privately operated car parks, which addresses at least some of the problems of known systems.

The present invention is directed towards providing such a method and a system for facilitating paying for a parking permit.

According to the invention there is provided a system for facilitating paying for a parking permit in a selected one of one or more pay-for-parking zones, the system comprising:
a plurality of visual display devices of respective clients of the system, each visual display device being responsive to a remotely generated signal for displaying the grant of a parking permit,
a central control terminal remote from the visual display devices, the central control terminal comprising:
a first storing means for storing the identity of the respective clients of the system and the identity of the respective visual display devices, with the identity of each visual display device cross-referenced with the identity of the corresponding client,
a second storing means for storing the cost per predetermined parking time unit of parking in each one of the pay-for-parking zones,
a telecommunications receiving means for receiving communications from the clients of the system, whereby each communication containing a request for a permit is indicative of the identity of the client and a selected zone for which a parking permit is required,
a computing means for computing the cost of a parking permit in response to a received request for a parking permit from one of the clients,
a means for debiting an account of each client with the cost of a parking permit requested by the corresponding client, and
a communicating means for communicating a signal indicative of particulars of each granted parking permit to the visual display device of the corresponding client in response to a request therefor.

In one embodiment of the invention the communicating means comprises a telecommunication data link for transferring particulars of each granted parking permit to a radio paging network operator for relaying the particulars of the granted parking permit to the corresponding visual display device via a radio transmission.

Preferably, each signal indicative of the particulars of the grant of a parking permit communicated by the communicating means is indicative of the zone for which the parking permit is granted. Advantageously, each signal indicative of the particulars of the grant of a parking permit communicated by the communicating means is indicative of the time period for which the parking permit is granted. Ideally, each signal indicative of the particulars of the grant of a parking permit communicated by the communicating means is indicative of the expiry time of the granted parking permit.

In one embodiment of the invention each visual display device comprises a display means for displaying the particulars of the granted parking permit. Preferably, the display means of each visual display device is adapted for displaying particulars of the zone for which the parking permit is granted. Advantageously, the display means of each visual display device is adapted for displaying particulars of the expiry time of the parking permit. Alternatively, the display means of each visual display device is adapted for displaying the commencement time of the parking permit, and the duration for which the parking permit has been granted.

In another embodiment of the invention each visual display device comprises a means for interpreting the particulars of a granted parking permit from the corresponding signal communicated by the communicating means for display on the display means thereof. Preferably, the display means of each visual display device comprises a visual display screen.

In one embodiment of the invention each visual display device comprises a radio receiver for receiving a radio transmission containing particulars of a granted parking permit. Preferably, the radio receiver of each visual display device is adapted for receiving the particulars of a granted parking permit via a radio transmission on a radio paging network frequency. Advantageously, the radio receiver of each visual display device is adapted for receiving the particulars of a granted parking permit in any one of the following protocols:
Post Office Code Standardisation Advisory Group (POCSAG),
Radio Data System (RDS),
FLEX, or
ReFLEX.

In another embodiment of the invention the telecommunications receiving means of the central control terminal comprises a means for capturing the telephone number of the telephone from which each received communication is made for determining the identity of the client making the call.

In a further embodiment of the invention the central control terminal comprises a first validating means for validating the identity of the corresponding client of each received communication. Preferably, the first validating means compares the determined identity of the client of each received communication with the stored identities of the clients in the first storing means for determining if the determined identity is a valid identity of one of the clients.

In one embodiment of the invention the central control terminal comprises a third storing means for storing balances of accounts of at least some of the clients of the system cross-referenced with the respective client identities.

In a further embodiment of the invention the central control terminal comprises a second validating means for validating the granting of a requested parking permit. Preferably, the second validating means compares the computed cost of the requested parking permit with the balance in the account of the corresponding client in the third storing means, and the second validating means is responsive to the computed cost of the requested parking permit not exceeding the available balance in the account of the client for validating the grant of the requested parking permit. Advantageously, the communicating means is operated under the control of the central control terminal for communicating the particulars of the granted parking permit in response to the second validating means validating the grant thereof.

In one embodiment of the invention the means for debiting the account of each client with the cost of a requested parking permit is responsive to the particulars of the parking permit having been communicated by the communicating means to the corresponding visual display device for debiting the corresponding account in the third storing means.

In another embodiment of the invention the central control terminal comprises a means for permitting a client to transfer credit to the client's account in the third storing means.

In another embodiment of the invention the means for permitting a client to transfer a credit to the client's account comprises a means for receiving a code number of a purchased voucher supplied by an operator of the system, and a means is provided for reading the received code number, determining the value of the voucher from the code number, and crediting the value of the voucher to the client's account.

In a further embodiment of the invention the code number of the voucher is entered via the client's mobile telephone.

In a still further embodiment of the invention the means for permitting a client to transfer a credit to the client's account comprises a means for receiving a credit transfer transferred from an automatic teller machine (ATM) terminal.

In a still further embodiment of the invention the means for permitting a client to transfer a credit to the client's account comprises a means for receiving a credit transfer from a credit, debit or charge card account.

In one embodiment of the invention the telecommunications receiving means of the central control terminal is adapted for receiving data in a telephone call from a client indicative of a selected duration for which a parking permit is requested. Preferably, the telecommunications receiving means of the central control terminal is adapted for interpreting the duration for which a parking permit is requested from at least one digit entered by the client via the telephone of the client when the telephone communication to the receiving means is established.

In one embodiment of the invention the telecommunications receiving means of the central control terminal comprises a means for receiving telephone communications made to at least two different telephone numbers, the respective telephone numbers identifying respective corresponding pay-for-parking zones.

In another embodiment of the invention the telephone numbers to which the telecommunications receiving means of the central control terminal is adapted for receiving telephone communications are fixed-charge-per-call telephone numbers.

In a further embodiment of the invention the telephone numbers to which the telecommunications receiving means of the central control terminal is adapted for receiving telephone communications comprises at least one premium rate telephone number, and the means for debiting an account of a client with the cost of a requested parking permit causes the telephone account of the client to be debited with the cost of the parking permit.

Preferably, the system comprises a means for opening a new account for a new client.

Advantageously, each visual display device is adapted for locating on or in a motor vehicle, and ideally, each visual display device is adapted for mounting within a motor vehicle so that the visual display device is visible through a window or windscreen of the motor vehicle.

Preferably, the identities of the clients and the identities of the visual display devices are stored in electronic format.

Advantageously, the balances of the accounts of the clients stored in the third storing means are stored in electronic format.

In one embodiment of the invention the telecommunications receiving means for receiving communications from the clients of the system is adapted for receiving communications requesting parking permits in the form of a telephone call.

In another embodiment of the invention the telecommunications receiving means for receiving communications from the clients of the system is adapted for receiving communications requesting parking permits in the form of a telecommunications text message.

In a further embodiment of the invention the telecommunications receiving means for receiving communications from the client of the system is adapted for receiving communications requesting parking permits in the form of an SMS.

The invention also provides a method for facilitating paying for a parking permit in a selected one of one or more pay-for-parking zones comprising:
providing a plurality of clients with respective visual display devices for displaying the grant of a parking permit in response to a received signal,
storing the identity of the respective clients of the system in a first storing means of a central control terminal remote of the visual display devices, and storing the identity of the respective visual display devices in the first storing means, and cross-referencing the identity of each visual display device with the identity of the corresponding client in the first storing means,
storing the cost per predetermined parking time unit for parking in each one of the pay-for-parking zones in a second storing means of the central control terminal,
receiving communications from the clients through a telecommunications receiving means of the central control terminal, whereby each communication containing a request for a parking permit is indicative of the identity of the client, and a selected zone for which a parking permit is required,
computing the cost of a requested parking permit in response to a received request therefor by a computing means of the central control terminal,
debiting an account of the client with the cost of the parking permit, and
communicating a signal indicative of the particulars of the grant of each granted parking permit by a communicating means of the central control terminal to the visual display device of the corresponding client for activating the visual display device to display the parking permit.

In one embodiment of the invention the particulars of each granted parking permit are communicated via a telecommunications data link to a radio paging network operator for relaying via a radio transmission to the corresponding visual display device.

In one embodiment of the invention each signal indicative of the particulars of the grant of a parking permit communicated by the communicating means is indicative of the zone for which the parking permit is granted. Preferably, each signal indicative of the particulars of the grant of a parking permit communicated by the communicating means is indicative of the time period for which the parking permit is granted. Advantageously, each signal indicative of the particulars of the grant of a parking permit communicated by the communicating means is indicative of the expiry time of the granted parking permit.

Preferably, particulars of the zone for which a parking permit is granted is displayed on the corresponding visual display device. Advantageously, particulars of the expiry time of a parking permit are displayed on the corresponding visual display device.

In one embodiment of the invention particulars of the commencement time of a parking permit, and the duration for which the parking permit has been granted are displayed on a corresponding visual display device.

In one embodiment of the invention the particulars of the grant of a parking permit are interpreted by the corresponding visual display device from the signal communicated by the communicating means for display by the visual display device.

In another embodiment of the invention the particulars of each granted parking permit are received by the corresponding visual display device via radio transmission on a radio paging network frequency.

In one embodiment of the invention the particulars of each granted parking permit are received by the corresponding visual display device in any one of the following protocols:
Post Office Code Standardisation Advisory Group (POCSAG),
Radio Data System (RDS),
FLEX, or
ReFLEX.

In another embodiment of the invention the telephone number of the telephone from which each received call is made is captured for determining the identity of the client making the call.

Preferably, the identity of the client of each received call is validated by a first validating means. Advantageously, the determined identity of the client of each received call is compared with the stored identities of the clients in the first storing means by the first validating means for determining if the determined identity is a valid identity of one of the clients.

In one embodiment of the invention balances of accounts of at least some of the clients of the system are stored in a third storing means of the central control terminal, and the account balances are cross-referenced with the respective client identities.

In another embodiment of the invention the granting of a requested parking permit is validated by a second validating means. Preferably, the computed cost of a requested parking permit is compared with the balance in the account of the corresponding client in the third storing means by the second validating means and the grant of the requested parking permit validated if the computed cost of the parking permit does not exceed the available balance in the account of the client.

Advantageously, the balance of the account of the client is debited with the cost of the granted parking permit when the parking permit is communicated by the communicating means to the visual display device of the corresponding client.

In one embodiment of the invention the duration for which a parking permit is requestable is selectable.

In another embodiment of the invention a communication requesting a parking permit is made to a selected one of at least two telephone numbers, the respective telephone numbers identify respective pay-for-parking zones.

In another embodiment of the invention each visual display device is located on or in a motor vehicle of the client. Preferably, each visual display device is mounted within a motor vehicle of the client so that the visual display device is visible through a window or windscreen of the motor vehicle.

In one embodiment of the invention a communication requesting a parking permit may be made to a premium rate telephone number.

In another embodiment of the invention a communication requesting a parking permit may be made via a telephone call.

In a further embodiment of the invention a communication requesting a parking permit may be made via telecommunications text message.

In a still further embodiment of the invention a communication requesting a parking permit may be made via an SMS message.

The advantages of the invention are many. The system and method for paying for a parking permit according to the invention overcomes many if not all of the problems of known systems. Firstly, by virtue of the fact that the system provides display devices for displaying a parking permit, and the display devices are mountable in or on motor vehicles of the respective clients, there is no need to obtain a ticket from a ticket issuing machine. Furthermore, by virtue of the fact that the parking permit is communicated to the appropriate visual display device by a central control terminal, the need for the issuing of a ticket by a ticket issuing machine is entirely dispensed with. By virtue of the fact that the central control terminal comprises a receiving means for receiving a telephone communication, which may be a telephone call or a text message from a client requiring a parking permit, there is no need for the client to leave his or her motor vehicle to purchase a parking permit. The telephone communication may be made to the appropriate telephone number of the central control terminal while one is in the motor vehicle. Furthermore, since the parking permit is communicated by the central control terminal to the appropriate visual display device, the entire procedure of obtaining the parking permit may be carried out by the client while sitting in the motor vehicle. A particularly important advantage of the invention is achieved when the central control terminal comprises a third storing means for storing balances of accounts of respective clients, which can be debited for each requested parking permit. This avoids the need to carry change for paying for a parking permit, and furthermore, avoids the need for using a credit or charge card for paying for each single parking permit separately.

A client of the system may make payments of a reasonable size periodically in order to keep the balance of his or her account in credit to cover a reasonable number of parking permits. Where a client is making a payment to top up the balance on his or her account, the payment may be made by purchasing a voucher and communicating a code number of the voucher to the central control terminal. Alternatively, the payment may be made by a credit or charge card, or directly from an ATM (automatic teller machine) machine or the like. However, the amount being paid can be an amount of value appropriate to that which would typically be debited to a credit or charge card or the like. Thus, instead of having to pay for each individual parking permit by a credit or charge card, one can pay for a large number of parking permits in one transaction by the use of a voucher, a credit transfer initiated via an ATM machine, or by making a payment by a credit or charge card.

A further advantage of the invention is achieved when a granted parking permit is transmitted to the corresponding visual display device over a radio paging network, since the cost of transmission and the convenience of transmission using such networks is particularly efficient and cost effective.

Where the telecommunication receiving means of the central control terminal is adapted for receiving telephone communications to more than one telephone number, each of which identifies a corresponding zone, the system is particularly adaptable to local authority parking where cities and towns are divided into different pay-for-parking zones where the parking tariff per unit time period differs from zone to zone.

A further advantage of the method and system according to the invention is achieved when the system is adapted for receiving premium rate calls, since the tariff for the parking permit is charged directly against the telephone account of the individual making the call.

A still further advantage of the invention is that significant cost savings are achieved by the operator of the system, for example, a local authority or the like, since there is no longer the need to provide ticket issuing machines, all that is required is to provide particulars of the telephone number corresponding to the pay-for-parking zone to be dialed in order to obtain a parking permit for the relevant zone. The relevant telephone number may be displayed on a suitable road sign or by any other suitable means.

A further advantage of the invention is that a client of the system can at appropriate times top-up his or her account balance in the system by merely making a telephone call and entering the number of a purchased voucher, or alternatively, directly from an ATM machine, or by a credit or charge card.

The invention will be more clearly understood from the following description of a preferred embodiment thereof, which is given by way of example only, with reference to the accompanying drawings, in which:

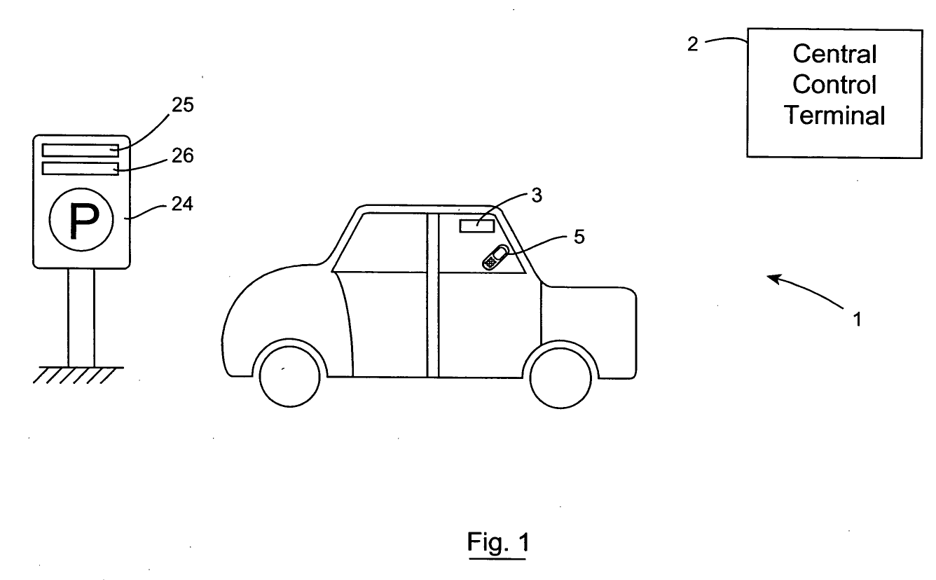

FIG. 1 is a schematic representation of a system according to the invention for facilitating paying for a parking permit in a selected one of one or more pay-for-parking zones,

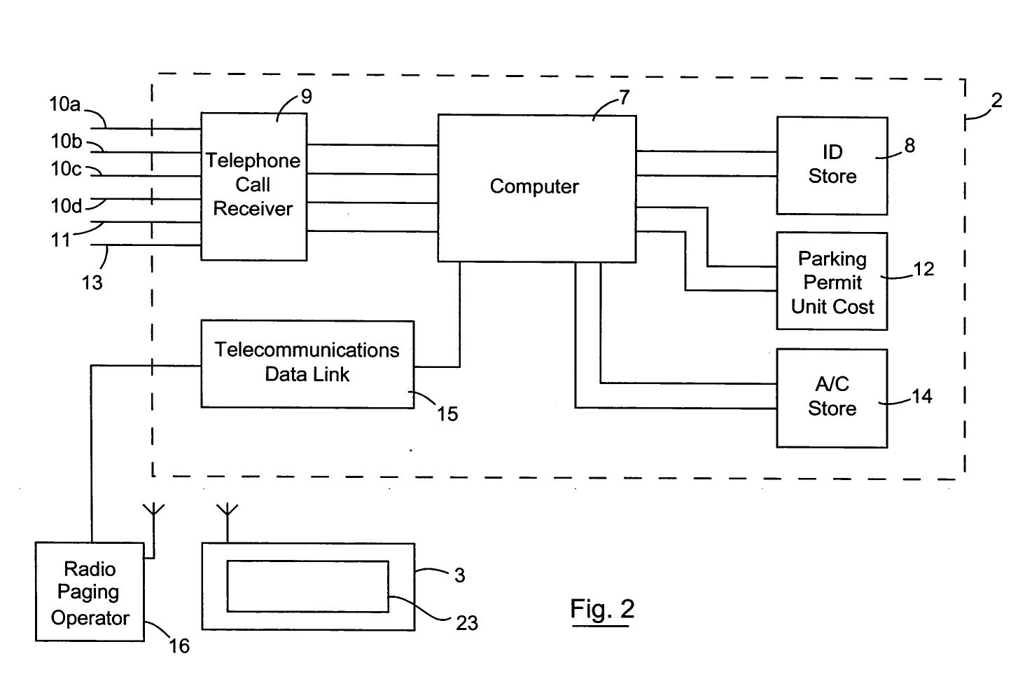

FIG. 2 is a block representation of a part of the system of FIG. 1,

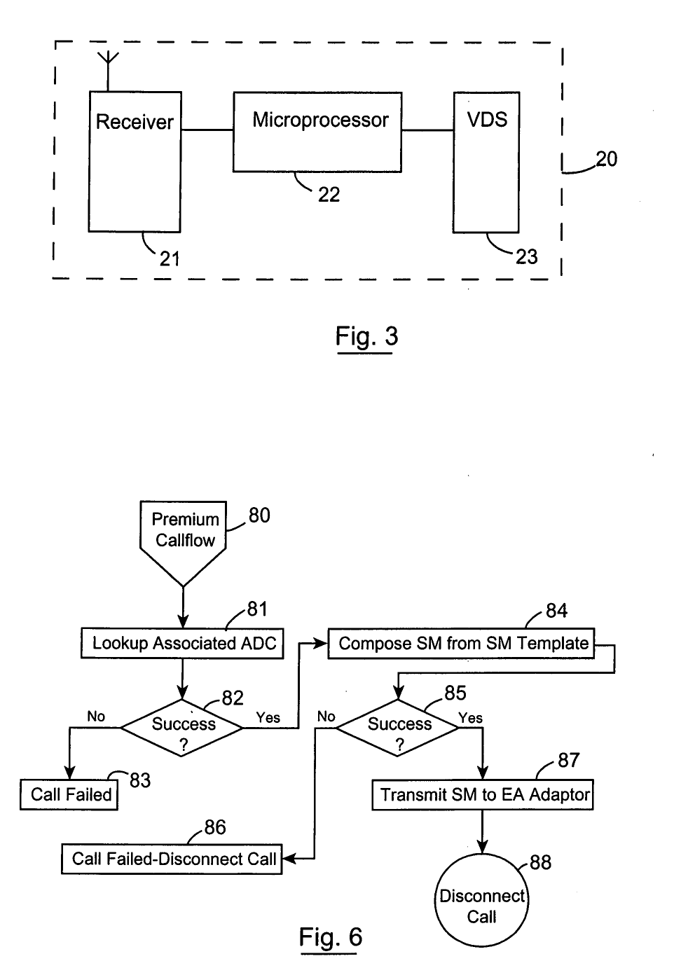

FIG. 3 is a block representation of a portion of the system of FIG. 1,

FIG. 4 is a flowchart of a first subroutine of a computer programme under which the system of FIG. 1 operates,

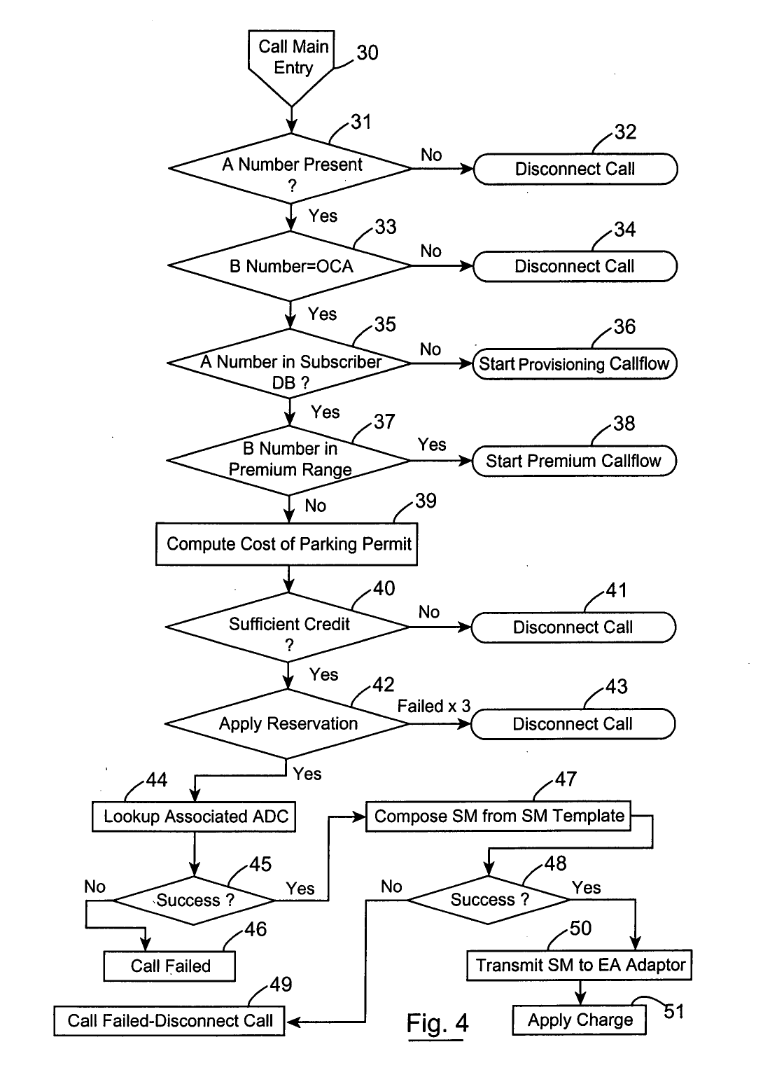

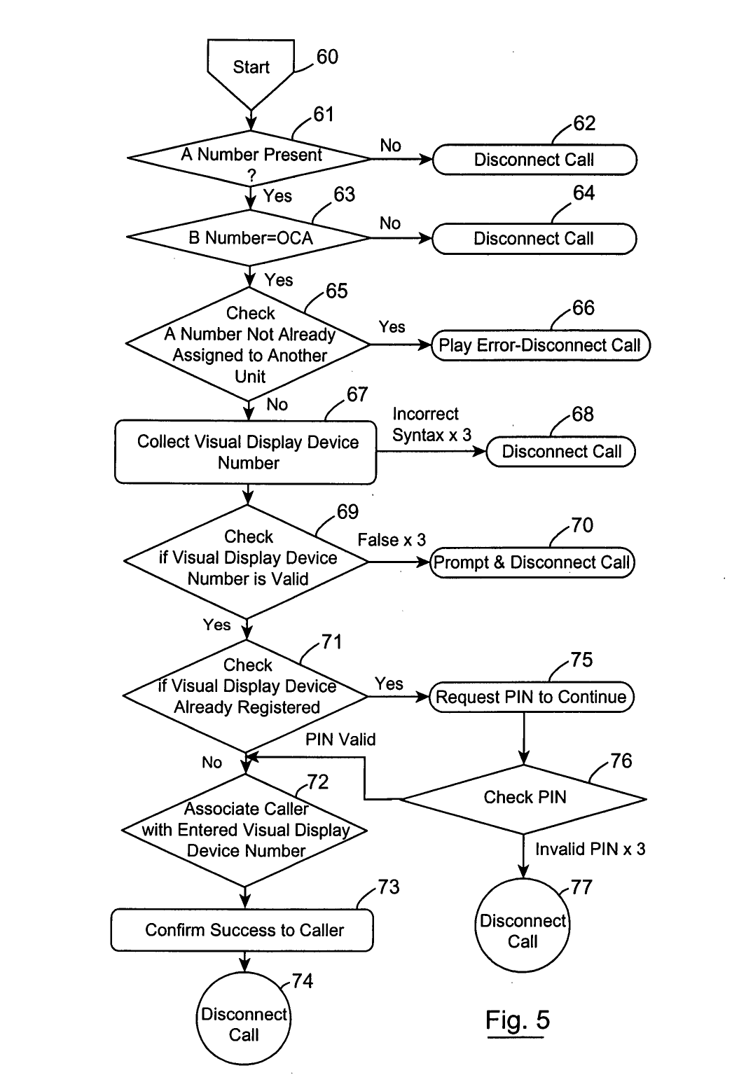

FIG. 5 is a flowchart of a second subroutine of the computer programme under which the system of FIG. 1 operates, and

FIG. 6 is a flowchart of a third subroutine of the computer programme under which the system of FIG. 1 operates.

Referring to the drawings, there is illustrated a system according to the invention, indicated generally by the reference numeral 1, for facilitating paying for a parking permit in a selected one of one or more pay-for-parking zones. The system 1 is particularly suited for use by local authorities for collecting revenue for on-street parking in streets or areas which are in pay-for-parking zones, and the cost of parking per predetermined parking time unit varies from zone to zone. The system 1 may be operated directly by a local authority, or by an authorised operator, and typically, will be operated by an authorised operator on behalf of a local authority. The system 1 comprises a central control terminal 2 which is computer driven for controlling and operating the system 1. Those wishing to avail of the system 1 for paying for parking, which hereinafter are referred to as clients, purchase a visual display device 3 which is suitable for mounting in a motor vehicle of the client for displaying the grant of a parking permit, as will also be described below. The visual display devices 3 are supplied by the authorised operator of the system 1, and are suitable, as will be described below, for receiving particulars of a granted parking permit via a radio paging network, and displaying the particulars of the granted parking permit. Each visual display device 3 is provided with a unique address code. On purchasing the visual display device 3, a client registers with the system 1 as will be described below, and the particulars of the client and the address code of the client are recorded and cross-referenced in the system 1.

Requests for parking permits are made through a mobile telephone 5 of the client via a cellular telephone network to the central control terminal 2, as will be described in detail below, and the grant of the parking permit is transmitted by a radio signal over a radio paging network to the visual display device 3 of the client. This is described in detail below.

Referring in particular to FIG. 2, the central control terminal 2, as mentioned above, is computer driven and comprises a computer 7, which controls the operation of the central control terminal 2. A first storing means for storing the identities of the respective clients of the system 1, and the identities of their respective visual display devices 3 in electronic format is provided by an ID memory 8, which is provided by any suitable computer readable medium, for example, a random access memory, which is writeable to and readable by the computer 7. In this embodiment of the invention each client is identified by the telephone number of his or her cellular telephone, from which the client will make telephone calls to the system 1 requesting parking permits. The address code of the visual display device 3 of each client is stored in the ID memory 8 as the identity of the visual display device 3, and the cellular telephone number of each client is cross-referenced with the address code of his or her visual display device 3 in the ID memory 8.

A telecommunications receiving means comprising a telephone call receiver 9 is provided in the central control terminal 2, and is provided with facilities for receiving telephone calls, text messages or SMS messages made to a plurality of fixed-charge-per-call telephone numbers, in this case four fixed-charge-per-call telephone numbers from the mobile telephones 5 of the respective clients requesting parking permits. In FIG. 2 the four fixed-charge-per-call telephone numbers are represented by the lines 10a to 10d. In this embodiment of the invention since the telephone call receiver 9 is provided for receiving telephone calls made to four fixed-charge-per-call telephone numbers 10a to 10d, the system 1 is suitable for use with four different pay-for-parking zones, and the respective four fixed-charge-per-call telephone numbers 10a to 10d are designated to corresponding ones of the respective four pay-for-parking zones. Thus, a client requiring a parking permit for the pay-for-parking zone 1 dials the telephone number 10a, while a client requesting a parking permit for the pay-for-parking zone 2 dials the telephone number 10b, and so on to a request for a parking permit for the pay-for-parking zone 4, which is made by a telephone call to the telephone number 10d. While the telephone numbers 10a to 10d are fixed-charge-per-call telephone numbers regardless of call length, in general, most telecommunications regulators impose an arbitrary upper limit on the length of such calls.

The telephone call receiver 9 also has facilities for receiving a telephone call made to a premium rate number represented by the line 11 in FIG. 2 from mobile telephones 5 of the clients, should a client wish to pay for a parking permit via a premium rate telephone call. The telephone call receiver 9 also has a facility for receiving a telephone call, text message or other SMS made to a telephone number represented by the line 13 in FIG. 2 for facilitating making payments to the system 1 as will be described below.

The telephone call receiver 9 is coupled to the computer 7, and the computer 7 reads the respective calls made to the telephone numbers 10a to 10d for identifying the pay-for-parking zones for which parking permits are being requested. The computer 7 also reads the calls made to the premium rate telephone number 11 and to the telephone number 13. The computer 7 captures the cellular telephone numbers of the cellular telephones of the clients making the telephone calls to the telephone numbers 10, 11 and 13 for identifying the clients. Additionally, when a request for a parking permit is made to one of the fixed-charge-per-call telephone numbers 10, the duration for which the parking permit is required is selectable and is entered via the mobile telephone of the client requesting the parking permit by dialing one of the digits from one to nine after the telephone call has been established between the mobile telephone 5 of the client and the telephone call receiver 9. The digits one to nine identify the duration for which the parking permit is required, dialing the digit one indicates a request for a parking permit for a duration of one predetermined parking time unit, dialing the digit two indicates the duration of, the required parking permit is two predetermined parking time units, and so on up to the digit nine, which indicates nine predetermined parking time units. A parking time unit may be any duration, which is assigned by the authorised operator or the local authority. For example, a parking time unit may be one hour, or may be a part of one hour, for example, one quarter of one hour. The computer 7 reads the digit entered by the mobile phone 5 when the call has been established in order to determine the number of predetermined parking time units for which the parking permit is required.

A second storing means for storing the cost per predetermined parking time unit for the respective pay-for-parking zones-comprises a parking permit unit cost memory 12, which may be any suitable electronic memory which is readable by the computer, and writeable to by the computer 7. The parking permit unit cost memory 12 stores the cost per predetermined parking time unit for parking permits in the respective four zones 1 to 4. The parking permit unit cost memory 12 is programmable by the computer 7 so that increases or decreases in the cost per predetermined parking time unit for a parking permit in the respective four zones can be readily altered.

A third storing means for storing balances of accounts of the respective clients of the system 1 comprises an electronic account storing memory 14, which may be any suitable electronic memory which is writeable to by the computer 7 and readable by the computer 7. The balances of the accounts of the respective clients are stored in the account memory 14 and the accounts of the clients are cross-referenced with the identities of the clients. On being registered as a client of the system 1, an initial payment made by each client is credited to the client's account balance. Periodically during use of the system 1, the respective clients make top-up payments in order to keep the balances in their accounts stored in the account memory 14 in credit, unless a credit facility is arranged with the client. A permit is not granted where the cost of the parking permit exceeds the available balance in the client's account, as will be described below. The initial and periodic top-up payments may be made by purchasing a voucher and entering a code of the voucher via a telephone call or a text message to the telephone number 13 of the telephone receiver 9, which is read by the computer 7. The vouchers are supplied by the authorised operator of the system 1, and are of varying values. The code provided on each voucher is unique to that voucher and identifies the value of the voucher. The computer 7 on reading the code of the voucher entered by the client to the telephone number 13, validates the voucher, and identifies the value of the voucher from the code thereof, and then credits the value of the voucher to the client's account. The initial and top-up payments may be made by a credit transfer from an ATM machine. Additionally, a facility is provided whereby a client can go online to his or her account stored in the account memory 14, credit his or her account balance by entering particulars of a credit, debit or charge card, and the amount to be debited against the credit, debit or charge card.

A communicating means, in this embodiment of the invention a telecommunications data link 15 links the central control terminal 2 to a radio paging network operator 16, and the particulars of each granted parking permit are communicated by the computer 7 via the data link 15 to the radio paging network operator 16 for radio transmission via the radio paging network to the visual display device 3 of the client. The computer 7 prepares the particulars of each granted parking permit in the form of a short message comprising one or more data packets which include the address code of the visual display device 3 to which the granted parking permit is to be transmitted, the expiry time of the granted parking permit, and the zone for which the parking permit is valid. The short message is prepared by the computer 7 from a short message template stored in memory of the computer 7, and is relayed via the data link 15 to the paging network operator for transmission over the paging network to the appropriate visual display device 3. In this embodiment of the invention the short message is transmitted using a paging network radio protocol, which in this embodiment of the invention is the Post Office Code Standardisation Advisory Group (POCSAG) protocol, although the data packets may be transmitted over the radio paging network to the appropriate visual display device 3 using Radio Data System (RDS) technology protocol, or FLEX or ReFLEX protocols of Motorola.

Referring to FIG. 3, each visual display device 3 comprises a housing 20 which is adapted for mounting in a suitable location in a motor vehicle to be visible through a front or rear windscreen or a side window of the motor vehicle in which the visual display device 3 is located. A radio receiver 21 is located in the housing 20 of each visual display device 3 for receiving the short message containing particulars of a granted parking permit from the central control terminal 2 in the POCSAG protocol. A microprocessor 22 located in the housing 20 reads short messages received by the radio receiver 21, and on a short message containing particulars of a parking permit being received, the microprocessor 22 interprets the short message and displays the particulars of the parking permit on a visual display screen 23 of the visual display device 3. The particulars of the parking permit displayed on the visual display screen 23 includes the expiry time of the parking permit and the zone for which the parking permit is valid.

In order that clients can readily identify the pay-for-parking zone for which a parking permit is required, a number of signs 24 are provided in each pay-for-parking zone indicating that parking is permissible, and also indicating at 25 the telephone number of the fixed-charge-per-parking telephone numbers 10a to 10d which is appropriate to the pay-for-parking zone, so that a client wishing to park in a particular zone can readily obtain the appropriate one of the fixed-charge-per-parking telephone numbers 10a to 10d to be dialed corresponding to the pay-for-parking zone to obtain a parking permit. Each sign 24 may also display the premium rate telephone number 11 at 26, which may also be dialed by a client to obtain a parking permit.

In use, a client registered with the system 1 and wishing to obtain a parking permit, the cost of which is to be debited to the client's account stored in the account memory 14, dials the fixed-charge-per-call telephone number 10a to 10d corresponding to the pay-for-parking zone for which the parking permit is required. The telephone call requesting the parking permit is made from the client's cellular telephone, the number of which is stored in the ID memory 8. On a telephone call being established, the computer 7 records the telephone number 10a to 10d to which the telephone call is made in order to identify the zone for which the parking permit is required, and the computer 7 captures the telephone number of the mobile telephone 5 of the client from which the telephone call is made in order to identify the client. The computer 7 then checks if the telephone number of the mobile telephone 5 is stored in the ID memory 8 in order to validate the call. On validation of the call the computer queries the client as to the duration for which the parking permit is required. The duration for which the parking permit is required is entered by entering the appropriate digit one to nine through the mobile telephone 5, indicating the duration in parking time units. The computer 7 on determining the duration for which the parking permit is required reads the cost per predetermined parking time unit for parking in the zone for which the parking permit is required from the parking permit unit cost memory 12, and computes the cost of the requested parking permit. The computer 7 then reads the available balance in the client's account stored in the account memory 14, and if the available balance is equal to or exceeds the cost of the parking permit, the computer validates the parking permit and reserves the cost of the parking permit in the account of the client. The computer 7 obtains the address code of the client's visual display device 3 from the ID memory 8, and prepares the particulars of the parking permit into data packets to form a short message, which is relayed via the data link 15 to the paging network operator 16, and transmitted by the paging network operator 16 to the client's visual display device 3 for display on the visual display screen 23 thereof.

When a potential new client wishes to register as a client with the system 1, the potential new client purchases one of the visual display devices 3 supplied by the authorised operator of the system 1, and makes a telephone call to the central control terminal 2 which may be made to any of the fixed-charge-per-call telephone numbers 10a to 10d of the telephone call receiver 9. The computer 7 on receiving the call in the normal way determines the pay-for-parking zone from the telephone number to which the call is made. However, in this case the zone is not relevant. The computer 7 captures the telephone number of the mobile telephone 5 of the potential new client and searches the ID memory 8 for a corresponding mobile telephone number. In the absence of finding a corresponding telephone number in the ID memory 8, the computer 7 queries the potential new client as to whether he or she wishes to register with the system 1 as a client. If so, the computer 7 requests full particulars of the potential new client, and the address code of the visual display device 3 purchased by the new client, which are entered by the potential new client while the call is in progress. The computer then stores the mobile telephone number of the new client and the address code of the visual display device 3 cross-referenced with each other in the ID memory 8, and opens a new account for the new client in the account memory 14. The address code of each visual display device 3 is printed on the visual display device.

Top-up payments to the system 1 may be made by purchasing one of the vouchers of the desired value issued by the authorised operator of the system 1. It is envisaged that such vouchers will be readily available in shops in areas where pay-for-parking is available, and in adjacent areas. On purchasing the voucher, the client makes the top-up payment by dialing the telephone number 13 and entering the code number of the voucher. The computer 7 captures the telephone number of the client and the code number of the voucher, and determines the value of the voucher, and credits the account of the client to the value of the voucher. Alternatively, top-up payments may be made via an ATM machine, or if desired, a top-up payment may be made using a credit, debit or charge card, as described above. Payments on registration are made in similar fashion.

Referring now to FIG. 4, a flowchart of a first subroutine is illustrated, which is executed by the computer 7 on receipt of a call from a client requesting a parking permit. Block 30 of the first subroutine starts the subroutine, and the subroutine moves to block 31, which checks if an A telephone number is present on the telephone call receiver 9. An A telephone number is the telephone number of a calling client. If no A number is present, the subroutine moves to block 32, which disconnects the call and returns the subroutine to block 30. If block 31 determines that an A number is present, block 31 captures that A number, namely, the telephone number of the client's mobile telephone from which the call is made, and records the A number. On capturing the A number of the call, the subroutine moves to block 33, which checks that the original B number called is one of the fixed-charge-per-call numbers 10a to 10d or the premium rate number 11, in order to prevent calls being diverted to the system from non-registered telephone numbers. If block 33 fails to determine or validate the B number to which the call is made, the subroutine moves to block 34, which disconnects the call, and returns the subroutine to block 30. If block 33 validates the B number, the B number is stored for determining the zone for which the parking permit is required and the subroutine moves to block 35. Block 35 searches the ID memory 8 for a telephone number which matches the captured A number, in order to validate the A number. If block 35 fails to find a matching telephone number in the ID memory 8, the subroutine moves to block 36, which calls up a second subroutine, which is described below with reference to FIG. 5 for initiating registration of a new client to the system 1. If block 35 finds a matching telephone number in the ID memory 8, the subroutine moves to block 37. Block 37 checks if the B number called is the premium rate number 11, and if so, the subroutine moves to block 38. Block 38 calls up a third subroutine which is described below with reference to FIG. 6 for issuing a parking permit in response to a request on a premium rate number.

If block 37 determines that the B number called is not the premium rate number 11, and thus must be one of the four fixed-charge-per-call telephone numbers 10a to 10d, the subroutine moves to block 39. Block 39 determines the duration for which the parking permit is required from the digit one to nine entered by the client, and reads the zone for which parking is required from the called B number. Block 39 also reads the appropriate cost per predetermined parking time unit for parking for the appropriate zone from the parking permit unit cost memory 12 and computes the cost of the parking permit requested. The subroutine then moves to block 40, which reads the available balance in the client's account from the account memory 14, and determines if the available balance in the client's account is equal to or exceeds the cost of the requested parking permit. If the available balance is not equal to or greater than the cost of the requested parking permit, block 40 queries the client if a parking permit to the available balance in the client's account would be acceptable, and queries the client three times. If after the third attempt the client does not indicate acceptance of a parking permit to the available balance in the client's account, the subroutine moves to block 41, which disconnects the call. If block 40 determines that either the available balance in the client's account is equal to or exceeds the cost of the requested parking permit, or the client has accepted a lower cost parking permit, the subroutine moves to block 42, which makes three attempts to reserve the cost of the requested parking permit in the client's account in the account memory 14. If after the third attempt block 42 fails to reserve the cost of the requested parking permit in the client's account in the account memory 14, the subroutine moves to block 43, which disconnects the call.

If block 42 successfully reserves the cost of the requested parking permit in the client's account in the account memory 14, the subroutine moves to block 44, which reads the address code of the visual display device 3 of the client from the ID memory 8, and the subroutine moves to block 45. Block 45 checks if the address code has been retrieved from the ID memory 8, and if not, the subroutine moves to block 46, which disconnects the call. Otherwise, the subroutine moves to block 47, which composes a short message from the short message template stored in the computer, which includes the address code of the client's visual display device and particulars of the parking permit granted. The subroutine then moves to block 48 which checks if the short message has been prepared, and if not, the subroutine moves to block 49, which disconnects the call. Otherwise, the subroutine moves to block 50, which relays the short message through the data link 15 to the paging network operator 16 for radio transmission to the client's visual display device 3, and the subroutine moves to block 51, which debits the reserved cost of the parking permit from the client's account in the account memory 14.

Referring now to FIG. 5, the second subroutine for registering a new client with the system 1 will now be described. Block 60 starts the subroutine, and the subroutine moves to block 61, which checks if an A number is present in similar fashion to that of block 31 of the first subroutine. If not, the subroutine moves to block 62, which disconnects the call. If block 61 determines that an A number is present, the subroutine moves to block 63 to validate the B number called in similar fashion to that of block 33 of the first subroutine. If block 63 fails to validate the B number, the subroutine moves to block 64, which disconnects the call. If block 63 validates the B number, the subroutine moves to block 65, which checks if the A number, in other words, the number of the caller, is already stored in the ID memory 8, and if so, the subroutine moves to block 66, which disconnects the call. Otherwise, the subroutine moves to block 67.

Block 67 requests the new client to enter the address code of the visual display device 3 purchased by the new client, and block 67 makes three attempts to obtain the address code from the new client. If block 67 fails to obtain the address code, the subroutine moves to block 68, which disconnects the call. Otherwise, the subroutine moves to block 69, which checks if the entered address code of the visual display device 3 is a valid address code, and if not, the subroutine moves to block 70, which disconnects the call. If block 69 determines that the entered address code is a valid address code, the subroutine moves to block 71. Block 71 searches the ID memory 8 to ascertain if the address code entered by the client is already stored in the ID memory 8, and if not, the subroutine moves to block 72, which stores the address code of the new client's visual display device in the ID memory 8, and cross-references the address code with the mobile telephone number of the client, namely, the A number. The subroutine then moves to block 73, which confirms that the address code of the new client's visual display device has been stored in the ID memory 8 and cross-referenced with the new client's telephone number in the ID memory 8. The subroutine then moves to block 74, which disconnects the call.

In this embodiment of the invention the system 1 may also be used by associates of a registered client who may wish to request a parking permit using the client's account stored in the account memory 14 to pay for the parking permit, but who would request the parking permit from a cellular telephone other than that of the client. In this case, the associates of the client must enter a PIN (personal identification number) when requesting a parking permit via a telephone other than that of the client. Accordingly, a provision is made for storing a PIN of each client in the ID memory 8, if the client wishes to permit associates to debit his or her account stored in the account memory 14, when requesting a parking permit. If block 71 determines that the address code of the client's visual display device 3 has already been stored in the ID memory 8, the subroutine moves to block 75, which requests a PIN number to be entered by the client, and moves to block 76. Block 76 checks three times if the PIN number is valid and in a valid format, and if not, the subroutine moves to block 77, which disconnects the call. If block 76 determines that the entered PIN number is in a valid format, the subroutine moves to block 72, which stores the entered PIN number in the ID memory 8 cross-referenced with the address code of the visual display device 3 of the client, and also cross-referenced with the telephone number of the client's mobile telephone in the ID memory 8.

Referring now to FIG. 6, there is illustrated a flowchart of the third subroutine for granting a parking permit in response to a call from a client made to the premium rate telephone number 11 of the telephone call receiver 9. Block 80 starts the subroutine, and the subroutine moves to block 81, which obtains the address code of the visual display device of the client from the ID memory 8, and the subroutine moves to block 82. Block 82 checks if the address code has been retrieved, and if not, the subroutine moves to block 83, which disconnects the call. Otherwise, the subroutine moves to block 84, which is similar to block 47 of the first subroutine of FIG. 4, which prepares a short message which includes the address code of the client's visual display device together with particulars of the parking permit. The subroutine then moves to block 85, which checks if the short message has been prepared, and if not, the subroutine moves to block 86, which disconnects the call. If block 85 determines that the short message has been prepared, the subroutine moves to block 87, which is similar to block 50 of the first subroutine of FIG. 4 and relays the short message through the data link 15 to the radio paging network operator 16 for transmission to the visual display device 3 of the client. The subroutine then moves to block 88, which disconnects the call. In this case, since the call was made to the premium rate number 11, the cost of the parking permit is debited against the client's telephone account, and thus, once the short message has been transmitted by block 87, block 87 can disconnect the call, since there is no need to debit the client's account with the cost of the parking permit.

In this embodiment of the invention the telephone call receiver 9 is adapted to receive calls to only one premium rate telephone number. Accordingly, a parking permit granted in response to a request made to the premium rate telephone number is based on a fixed cost, and is given for a fixed duration. The facility whereby the telephone receiver 9 is provided for receiving calls made to a premium rate telephone number is provided for emergency use only, when the available balance in a client's account is insufficient to meet the cost of a parking permit requested on one of the fixed charge call lines 10. However, it is envisaged that the telephone call receiver 9 may be adapted to receive calls on a plurality of premium rate numbers, and in which case, each number can be designated to a specific pay-for-parking zone. Thus, the subroutine for determining the cost of the parking permit requested on a call made to a premium rate number will determine the cost of the requested parking permit based on the zone for which the parking permit is requested, and the cost of the parking permit will be debited to the telephone account of the client.

While the system 1 has been described as having provision for receiving calls for parking permits made to a premium rate telephone number, in certain cases, it is envisaged that the system may be provided for receiving calls for parking permits made to fixed-charge-per-call telephone numbers, and in which case, a client would in general have to have a positive credit balance in his or her account in the account memory, although it will be appreciated by those skilled in the art that if the operator of the system were prepared to operate on a credit basis, the system 1 could be operated with clients' accounts with negative balances, and the clients would be billed at the end of a billing period, for example, on a monthly or quarterly basis.

Additionally, while the system has been described as being suitable for receiving calls from mobile telephones, it will be appreciated by those skilled in the art that the system may be operated to receive calls made from land lines and/or mobile telephones, although needless to say, in general, it would be more convenient for clients to be able to access the system from a mobile telephone.

While the system according to the invention facilitates selecting the duration for which a parking permit is required, in certain cases, it is envisaged that provision may not be provided for facilitating selecting of the duration, and in which case, the system on receiving a valid telephone call made to one of the fixed-charge-per-call telephone numbers would merely issue a parking permit for a fixed time. In which case, the client would not be queried as to the duration for which the parking permit is required.

While the telecommunications receiving means has been described as being a telephone call receiver, any other suitable telecommunications receiving means may be provided, and in certain cases, it is envisaged that the telecommunications receiving means would be capable of receiving requests for parking permits via e-mail, or by other SMS messaging means. Additionally, while the telecommunications receiving means has been described as being suitable for receiving requests for parking permits on fixed-charge-per-call telephone numbers and premium rate telephone numbers, it is envisaged in certain cases, that the requests for parking permits may be received on any type of telephone number. It is also envisaged that while the telecommunications receiving means has been provided with a telephone line for facilitating topping up of the client's credit balances in their respective accounts, in certain cases, it is envisaged that topping up of a client's credit balance may be carried out via one of the fixed-charge-per-call telephone numbers, or the premium rate telephone number. Additionally, it is envisaged that the telecommunications receiving means may be provided with a separate dedicated telephone line for facilitating registration of a new client with the system.

While the system has been described as including road signs with the relevant telephone numbers for requesting a parking permit provided on the road signs, the relevant telephone numbers may be provided in any suitable location or in any suitable means which is accessible to a client, and in certain cases, the relevant telephone numbers may be provided to the clients on a road map.

1-66. (canceled)

67. A system for facilitating paying for a parking permit in a selected one of one or more pay-for-parking zones, the system comprising:
a plurality of visual display devices of respective clients of the system, each visual display device being responsive to a remotely generated signal for displaying the grant of a parking permit,
a central control terminal remote from the visual display devices, the central control terminal comprising:
a first storing means for storing the identity of the respective clients of the system and the identity of the respective visual display devices, with the identity of each visual display device cross-referenced with the identity of the corresponding client,
a second storing means for storing the cost per predetermined parking time unit of parking in each one of the pay-for-parking zones,
a telecommunications receiving means for receiving communications from the diets of the system, whereby each communication containing a request for a permit is indicative of the identity of the client and a selected zone for which a parking permit is required,
a computing means for computing the cost of a parking permit in response to a received request for a parking permit from one of the clients,
a means for debiting an account of each client with the cost of a parking permit requested by the corresponding client, and
a communicating means for communicating a signal indicative of particulars of each granted parking permit to the visual display device of the corresponding client in response to a request therefor.

68. A system as claimed in claim 67 in which the communicating means comprises a telecommunication data link for transferring particulars of each granted parking permit to a radio paging network operator for relaying the particulars of the granted parking permit to the corresponding visual display device via a radio transmission.

69. A system as claimed in claim 67 in which each signal indicative of the particulars of the grant of a parking permit communicated by the communicating means is indicative of the zone for which the parking permit is granted, and preferably, each signal indicative of the particulars of the grant of a parking permit communicated by the communicating means is indicative of the time period for which the parking permit is granted, and advantageously, each signal indicative of the particulars of the grant of a parking permit communicated by the communicating means is indicative of the expiry time of the granted parking permit.

70. A system as claimed in claim 67 in which each visual display device comprises a display means for displaying the particulars of the granted parking permit, and preferably, the display means of each visual display device is adapted for displaying particulars of the zone for which the parking permit is granted, and advantageously, the display means of each visual display device is adapted for displaying particulars of the expiry time of the parking permit, and preferably, the display means of each visual display device is adapted for displaying the commencement time of the parking permit, and the duration for which the parking permit has been granted, and advantageously, each visual display device comprises a means for interpreting the particulars of a granted parking permit from the corresponding signal communicated by the communicating means for display on the display means thereof, and preferably, the display means of each visual display device comprises a visual display screen, and preferably, each visual display device comprises a radio receiver for receiving a radio transmission containing particulars of a granted parking permit, and advantageously, the radio receiver of each visual display device is adapted for receiving the particulars of a granted parking permit via a radio transmission on a radio paging network frequency, and preferably, the radio receiver of each visual display device is adapted for receiving the particulars of a granted parking permit in any one of the following protocols:
Post Office Code Standardisation Advisory Group (POCSAG),
Radio Data System (RDS),
FLEX, or
ReFLEX.

71. A system as claimed in claim 67 in which the telecommunications receiving means of the central control terminal comprises a means for capturing the telephone number of the telephone from which each received communication is made for determining the identity of the client making the call, and preferably, the central control terminal comprises a first validating means for validating the identity of the corresponding client of each received communication, and preferably, the first validating means compares the determined identity of the client of each received communication with the stored identities of the clients in the first storing means for determining if the determined identity is a valid identity of one of the clients.

72. A system as claimed in claim 67 in which the central control terminal comprises a third storing means for storing balances of accounts of at least some of the clients of the system cross-referenced with the respective client identities.

73. A system as claimed in claim 72 in which the central control terminal comprises a second validating means for validating the granting of a requested parking permit, and preferably, the second validating means compares the computed cost of the requested parking permit with the balance in the account of the corresponding client in the third storing means, and the second validating means is responsive to the computed cost of the requested parking permit not exceeding the available balance in the account of the client for validating the grant of the requested parking permit, and advantageously, the communicating means is operated under the control of the central control terminal for communicating the particulars of the granted parking permit in response to the second validating means validating the grant thereof.

74. A system as claimed in claim 72 in which the means for debiting the account of each client with the cost of a requested parking permit is responsive to the particulars of the parking permit having been communicated by the communicating means to the corresponding visual display device for debiting the corresponding account in the third storing means, and preferably, the central control terminal comprises a means for permitting a client to transfer credit to the client's account in the third storing means, and advantageously, the means for permitting a client to transfer a credit to the client's account comprises a means for receiving a code number of a purchased voucher supplied by an operator of the system, and a means is provided for reading the received code number, determining the value of the voucher from the code number, and crediting the value of the voucher to the client's account, and advantageously, the code number of the voucher is entered via the client's mobile telephone, and preferably, the means for permitting a client to transfer a credit to the client's account comprises a means for receiving a credit transfer transferred from an automatic teller machine ((New) ATM) terminal, and advantageously, the means for permitting a client to transfer a credit to the client's account comprises a means for receiving a credit transfer from a credit, debit or charge card account.

75. A system as claimed in claim 67 in which the telecommunications receiving means of the central control terminal is adapted for receiving data in a telephone call from a client indicative of a selected duration for which a parking permit is requested, and preferably, the telecommunications receiving means of the central control terminal is adapted for interpreting the duration for which a parking permit is requested from at least one digit entered by the client via the telephone of the client when the telephone communication to the receiving means is established, and advantageously, the telecommunications receiving means of the central control terminal comprises a means for receiving telephone communications made to at least two different telephone numbers, the respective telephone numbers identifying respective corresponding pay-for-parking zones, and preferably, the telephone numbers to which the telecommunications receiving means of the central control terminal is adapted for receiving telephone communications are fixed-charge-per-call telephone numbers, and advantageously, the telephone numbers to which the telecommunications receiving means of the central control terminal is adapted for receiving telephone communications comprises at least one premium rate telephone number, and the means for debiting an account of a client with the cost of a requested parking permit causes the telephone account of the client to be debited with the cost of the parking permit, and preferably, the system comprises a means for opening a new account for a new client.

76. A system as claimed in claim 67 in which each visual display device is adapted for locating on or in a motor vehicle, and preferably, each visual display device is adapted for mounting within a motor vehicle so that the visual display device is visible through a window or windscreen of the motor vehicle.

77. A system as claimed in claim 67 in which the identities of the clients and the identities of the visual display devices are stored in electronic format, and preferably, the balances of the accounts of the clients stored in the third storing means are stored in electronic format.

78. A system as claimed in claim 67 in which the telecommunications receiving means for receiving communications from the clients of the system is adapted for receiving communications requesting parking permits in the form of a telephone call, and preferably, the telecommunications receiving means for receiving communications from the clients of the system is adapted for receiving communications requesting parking permits in the form of a telecommunications text message, and advantageously, the telecommunications receiving means for receiving communications from the client of the system is adapted for receiving communications requesting parking permits in the form of an SMS.

79. A method for facilitating paying for a parking permit in a selected one of one or more pay-for-parking zones comprising:
providing a plurality of clients with respective visual display devices for displaying the grant of a parking permit in response to a received signal,
storing the identity of the respective clients of the system in a first storing means of a central control terminal remote of the visual display devices, and storing the identity of the respective visual display devices in the first storing means, and cross-referencing the identity of each visual display device with the identity of the corresponding client in the first storing means,
storing the cost per predetermined parking time unit for parking in each one of the pay-for-parking zones in a second storing means of the central control terminal,
receiving communications from the clients through a telecommunications receiving means of the central control terminal, whereby each communication containing a request for a parking permit is indicative of the identity of the client, and a selected zone for which a parking permit is required,
computing the cost of a requested parking permit in response to a received request therefor by a computing means of the central control terminal,
debiting an account of the client with the cost of the parking permit, and
communicating a signal indicative of the particulars of the grant of each granted parking permit by a communicating means of the central control terminal to the visual display device of the corresponding client for activating the visual display device to display the parking permit.

80. A method as claimed in claim 79 in which the particulars of each granted parking permit are communicated via a telecommunications data link to a radio paging network operator for relaying via a radio transmission to the corresponding visual display device.

81. A method as claimed in claim 79 in which each signal indicative of the particulars of the grant of a parking permit communicated by the communicating means is indicative of the zone for which the parking permit is granted, and preferably, each signal indicative of the particulars of the grant of a parking permit communicated by the communicating means is indicative of the time period for which the parking permit is granted, and advantageously, each signal indicative of the particulars of the grant of a parking permit communicated by the communicating means is indicative of the expiry time of the granted parking permit.

82. A method as claimed in claim 79 in which particulars of the zone for which a parking permit is granted is displayed on the corresponding visual display device, and preferably, particulars of the expiry time of a parking permit are displayed on the corresponding visual display device, and advantageously, particulars of the commencement time of a parking permit, and the duration for which the parking permit has been granted are displayed on a corresponding visual display device, and preferably, the particulars of the grant of a parking permit are interpreted by the corresponding visual display device from the signal communicated by the communicating means for display by the visual display device, and advantageously, the particulars of each granted parking permit are received by the corresponding visual display device via radio transmission on a radio paging network frequency, and preferably, the particulars of each granted parking permit are received by the corresponding visual display device in any one of the following protocols:
Post Office Code Standardisation (New) Advisory Group (POCS(New) AG),
Radio Data System (RDS),
FLEX, or
ReFLEX.

83. A method as claimed in claim 79 in which the telephone number of the telephone from which each received call is made is captured for determining the identity of the client making the call, and preferably, the identity of the client of each received call is validated by a first validating means, and advantageously, the determined identity of the client of each received call is compared with the stored identities of the clients in the first storing means by the first validating means for determining if the determined identity is a valid identity of one of the clients, and preferably, balances of accounts of at least some of the clients of the system are stored in a third storing means of the central control terminal, and the account balances are cross-referenced with the respective client identities, and advantageously, the granting of a requested parking permit is validated by a second validating means, and preferably, the computed cost of a requested parking permit is compared with the balance in the account of the corresponding client in the third storing means by the second validating means and the grant of the requested parking permit validated if the computed cost of the parking permit does not exceed the available balance in the account of the client, and preferably, the balance of the account of the client is debited with the cost of the granted parking permit when the parking permit is communicated by the communicating means to the visual display device of the corresponding client.

84. A method as claimed in claim 79 in which the duration for which a parking permit is requestable is selectable, and preferably, a communication requesting a parking permit is made to a selected one of at least two telephone numbers, the respective telephone numbers identify respective pay-for-parking zones.

85. A method as claimed in claim 79 in which each visual display device is located on or in a motor vehicle of the client, and preferably, each visual display device is mounted within a motor vehicle of the client so that the visual display device is visible through a window or windscreen of the motor vehicle.

86. A method as claimed in claim 79 in which a communication requesting a parking permit may be made to a premium rate telephone number, and preferably, a communication requesting a parking permit may be made via a telephone call, and advantageously, a communication requesting a parking permit may be made via telecommunications text message, and preferably, a communication requesting a parking permit may be made via an SMS message.
